(19) United States
(12) Patent Application Publication
(10) Pub. No.: US 2003/0037196 A1
(43) Pub. Date: Feb. 20, 2003

(54) Data access device function mode automatic switching control arrangement

(76) Inventor: Chin-Hsiang Chung, Taipei City (TW)

Correspondence Address: Robert E. Bushnell, 1522 K Street, N.W., Suite 300, Washington, DC, 20005-1202, US

(21) Appl. No.: 09/929,349

(22) Filed: Aug. 15, 2001

(51) Int. Cl. G06F 3/00; G06F 3/02; G06F 3/023; G06F 3/05; G06F 3/06; G06F 5/00; G06F 13/14

(52) U.S. Cl. 710/305

(57) ABSTRACT

A data access device function mode automatic switching control arrangement includes a data access main unit and a connecting device adapted to connect the data access main unit to a computer, the data access main unit switching the PCMCIA/CARD BUS interface card of the connecting device between PCMCIA function mode and CARD BUS function mode, enabling the data access device to be connected to the control unit of the PCMCIA/CARD BUS interface card directly or through the adapter board of the data access main unit subject to the status of external power supply at the power jack of the adapter board of the data access main unit.

### BACKGROUND OF THE INVENTION

The present invention relates to a data access device function mode automatic switching control arrangement and, more particularly, to such a data access device function mode automatic switching control arrangement, which automatically switches the PCMCIA/CARD BUS interface card between PCMCIA function mode and CARD BUS function mode subject to the presence of external power supply at the power jack of the adapter board of the data access main unit.

Following fast development of computer technology, the design of personal computer trends to sophisticated function and high operational speed, in consequence, the number of communication ports of a computer for peripheral apparatus is relatively reduced. Current commercially available computers have a PCMCIA (Personal Computer Memory Card International Association) interface design. PCMCIA is a memory card standard defined by the USA and Japan for use in personal computers, more particularly, notebook computers, for computer function expansion. A computer of PCMCIA design can be attached with memory card, network interface card, modem card, SCSI apparatus (for example, high capacity hard disk drive or scanner), etc. The capacity of a PCMCIA memory card can be as high as 64 MB. There are designs to convert PCMCIA to other interfaces, for example, PCMCIA to SCSI, PCMCIA to IDE, etc. When a PCMCIA interface card uses 8 MHz time pulse, the data bus bandwidth is 16 bites. Most notebook computers support plug-and-play. Some notebook computers also support hot plug. A PCMCIA interface card uses 5V for working, which is obtained from the computer.

Recently, computer manufacturers developed a new generation PC Card Standard, which chiefly uses a 32-bite Card Bus with 20/33 MHz time pulse to provide 132 MBps transmission speed. This design requires 3.3 V working voltage. Basically, this design uses PCI bus technology to provide an interface for a computer PCMCIA interface card. A card bus obviously is a card-like bus. Similar to a PCMCIA interface card, the connector for a card bus is a 68-pin interface design.

Therefore, PCMCIA interface cards and Card Bus interface cards have been intensively used in computer peripheral apparatus. The thickness difference between the housing of a PCMCIA interface card and the housing of a Card Bus interface card is insignificant. Because PCMCIA interface cards and Card Bus interface cards commonly have a 68-pin interface design, a common socket can be made capable of receiving a PCMCIA interface card as well as a Card Bus interface card. There are known a PCMCIA and CARD BUS integrated device, which has a function mode switch for switching between PCMCIA function mode and CARD BUS function mode. However, this PCMCIA and CARD BUS integrated device is not convenient in use because the function mode switch must be switched between PCMCIA function mode and CARD BUS function mode manually.

### SUMMARY OF THE INVENTION

The present invention has been accomplished under the circumstances in view. It is the main object of the present invention to provide a data access device function mode automatic switching control arrangement, which automatically switches the PCMCIA/CARD BUS interface card between PCMCIA function mode and CARD BUS function mode, enabling the data access device to be connected to the PCMCIA/CARD BUS interface card directly or through the adapter board of the data access main unit subject to the status of external power supply at the power jack of the adapter board of the data access main unit.

### BRIEF DESCRIPTION OF THE DRAWINGS

FIG. 1 is an elevational view showing the outer appearance of the present invention.

FIG. 2 shows the connecting device disconnected from the data access main unit according to the present invention.

FIG. 3 is a circuit block diagram of the present invention.

FIG. 4 illustrates the connecting device connected between the data access main unit and the computer according to the present invention.

FIG. 5 is a circuit block diagram of the present invention after connection to the computer.

### DETAILED DESCRIPTION OF THE PREFERRED EMBODIMENT

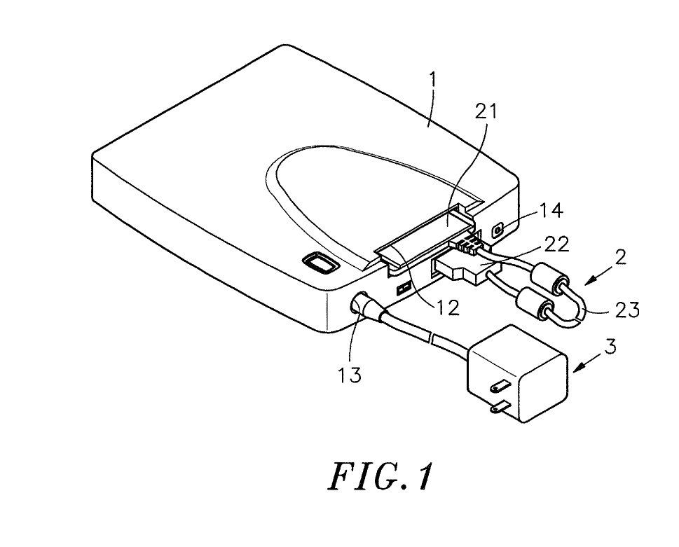

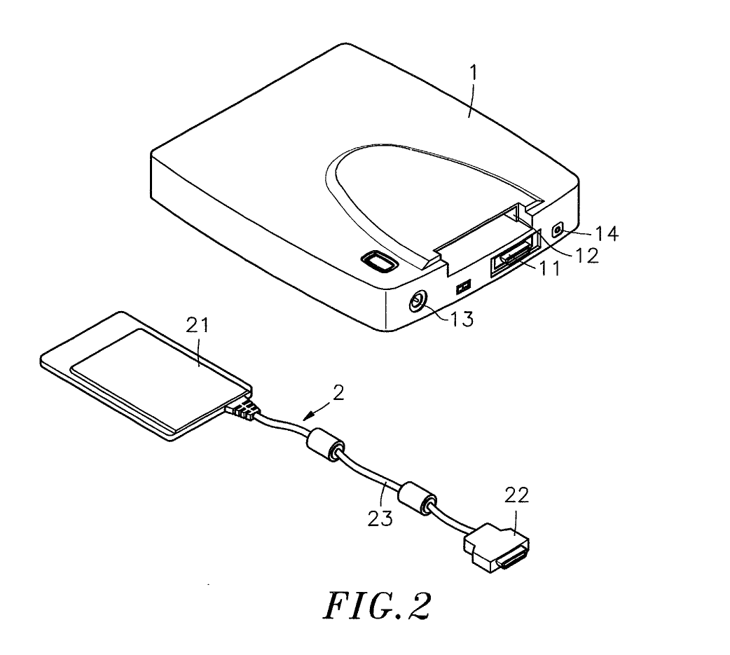

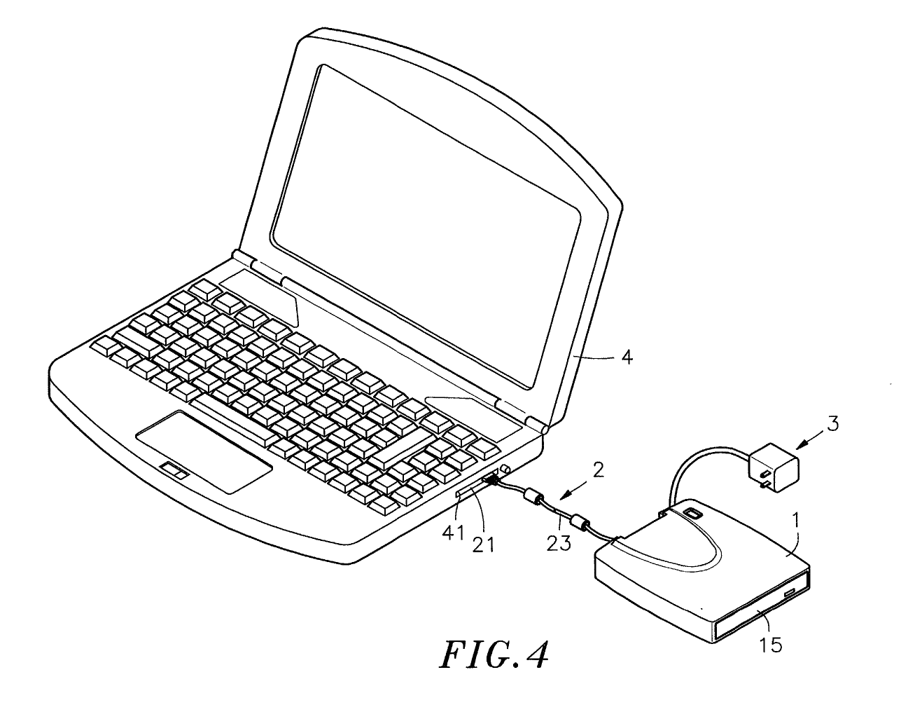

Referring to FIGS. 1 and 2, the present invention comprises a data access main unit 1, and a connecting device 2. The data access main unit 1 is a box-like device comprises a signal socket 11 having 68 pins, a storage chamber 12, a power jack 13, and an AV (audio video) jack 14 respectively disposed at one side. The power jack 13 is adapted to receive an AC adapter 3, which provides 12V DC power supply to the data access main unit 1. The AV jack 14 is adapted to receive a transmission line for audio/video signal output to external audio/video equipment. The data access main unit 1 further comprises a data access device 15 disposed at an opposite side (see FIG. 4).

The connecting device 2 comprises a transmission line 23, an interface card 21 constructed subject to PCMCIA and Card Bus standards and connected to one end of the transmission line 23, and a signal plug 22 connected to the other end of the transmission line 23. When in use, the interface card 21 is inserted into one I/O port 41 of the computer 4, and the signal plug 22 is connected to the signal socket 11 of the data access main unit 1 (see FIG. 4). When not in use, the interface card 21 is disconnected from the I/O port 41 of the computer 4 and received in the storage chamber 12 of the data access main unit 1.

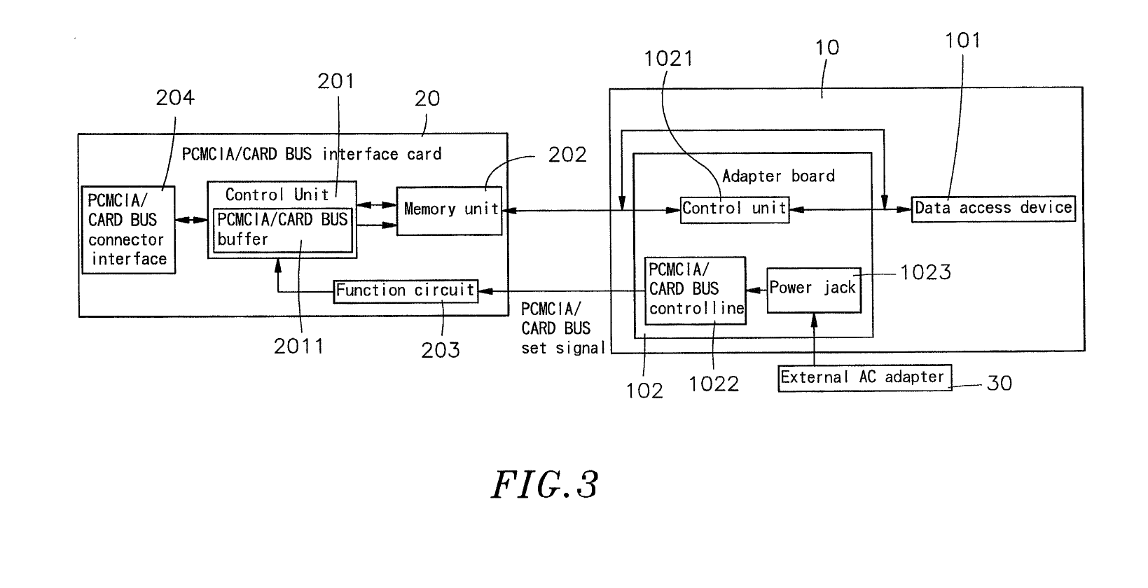

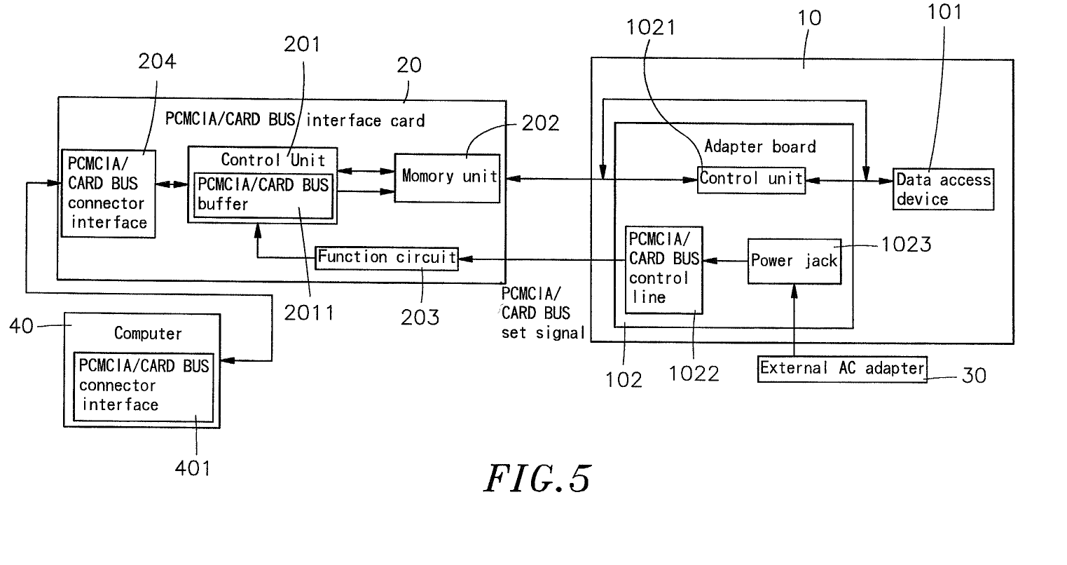

Referring to FIGS. 3 and 5, the data access main unit 10 comprises a data access device 101, and an adapter board 102. The data access device 101 can be directly connected to the memory unit 202 of the interface card 20. Alternatively, the data access device 101 can be connected to the memory unit 202 of the interface card 20 through the adapter board 102. The power jack 1023 of the adapter board 102 is connected to the PCMCIA/CARD BUS control line 1022, which is connected to the function circuit 203 of the interface card 20. The memory unit 202 and the function circuit 203 of the interface card 20 are respectively connected to the control unit 201. When power supply is connected from the external AC adapter 30 to the power jack 1023 of the adapter board 102, the control line 1022 transmits electronic signal to the function circuit 203 of the interface card 20, and the function circuit 203 of the interface card 20 immediately transmits received signal from the control line 1022 to the PCMCIA/CARD BUS buffer 2011 in the control unit 201, enabling the PCMCIA/CARD BUS buffer 2011 to set the interface card 20 into the Card Bus function mode for further operation. On the contrary, when external power supply is disconnected from the power jack 1023 of the adapter board 102, the PCMCIA/CARD BUS buffer 2011 sets the interface card 20 into the PCMCIA function mode for further operation.

After the interface card 20 has been set into the Card Bus function mode or the PCMCIA function mode, the PCMCIA/Card Bus connector interface 204 of the interface card 20 is connected to the PCMCIA/Card Bus connector interface 401 of the computer 40, for enabling the computer 40 to fetch data from or write data into the memory unit 202 and the data access device 101.

Further, the data access device 101 of the data access main unit 10 can be a hard disk drive, a detachable disk drive, a card reader, a programmer, or a CD-ROM player.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A data access device function mode automatic switching control arrangement comprising:
a data access main unit, said data access main unit comprising a signal socket, a data access device connected to said signal socket, and an adapter board connected to said signal socket, said adapter board comprising a power jack adapted to receive an external AC adapter; and
a connecting device adapted to connect said data access main unit to a computer for enabling said computer to access said data access main unit, said connecting device comprising a transmission line, an interface card constructed subject to PCMCIA and Card Bus standards and connected to one end of said transmission line for connection to an I/O port of a computer, and a signal plug connected to an opposite end of said transmission line for connection to the signal socket of said data access main unit;
wherein said adapter board outputs an electronic signal to said connecting device, causing said connecting device to be switched between PCMCIA function mode and CARD BUS function mode subject to the status of external power supply at said power jack.

2. The data access device function mode automatic switching control arrangement as claimed in claim 1 wherein said adapter board outputs an electronic signal to switch said connecting device to CARD BUS function mode upon the presence of external power supply at said power jack.

3. The data access device function mode automatic switching control arrangement as claimed in claim 1 wherein said adapter board outputs an electronic signal to switch said connecting device to PCMCIA function mode when external power supply is disconnected from said power jack.

4. The data access device function mode automatic switching control arrangement as claimed in claim 1 wherein said adapter board is comprised of control unit, a PCMCIA/CARD BUS control line, and said power jack; said interface card is comprised of a control unit, said control unit having a PCMCIA/CARD BUS buffer, a function circuit, a memory unit, and a PCMCIA/CARD BUS interface.

5. The data access device function mode automatic switching control arrangement as claimed in claim 4 wherein said power jack of said adapter board is connected said PCMCIA/CARD BUS control line, and said PCMCIA/CARD BUS control line is connected to the function circuit of said interface card, for enabling the function circuit to transmit electronic signal from said PCMCIA/CARD BUS control line of said adapter board to the PCMCIA/CARD BUS buffer of said control unit of said interface card to further switch said interface card between PCMCIA function mode and CARD BUS function mode subject to the presence of external power supply at said power jack.

6. The data access device function mode automatic switching control arrangement as claimed in claim 4 wherein said control unit of said interface card is connected to said memory unit for enabling said memory unit to be directly connected to said data access device or connected to said data access device through said adapter board for two-way signal transmission subject to PCMCIA function mode or CARD BUS function mode of said connecting device.

7. The data access device function mode automatic switching control arrangement as claimed in claim 1 wherein said data access device is a hard disk drive.

8. The data access device function mode automatic switching control arrangement as claimed in claim 1 wherein said data access device is a detachable disk drive.

9. The data access device function mode automatic switching control arrangement as claimed in claim 1 wherein said data access device is a card reader.

10. The data access device function mode automatic switching control arrangement as claimed in claim 1 wherein said data access device is a programmer.

11. The data access device function mode automatic switching control arrangement as claimed in claim 1 wherein said data access device is a CD-ROM player.

12. The data access device function mode automatic switching control arrangement as claimed in claim 1 wherein said data access main unit comprises a storage chamber adapted to receive said interface card of said connecting device when not in use.
